(19) United States
(12) Patent Application Publication
(10) Pub. No.: US 2025/0181989 A1
(43) Pub. Date: Jun. 5, 2025

(54) CLASSIFYING RELEVANCE OF TRAINING DATA TO A HIERARCHY OF USERS

(71) Applicant: International Business Machines Corporation, Armonk, NY (US)

(72) Inventors: Vinod Muthusamy, Austin, TX (US); Vatche Isahagian, Belmont, MA (US); David John Piorkowski, White Plains, NY (US); Yara Rizk, Cambridge, MA (US)

(21) Appl. No.: 18/523,969

(22) Filed: Nov. 30, 2023

(51) Int. Cl. G06N 20/20

(52) U.S. Cl. CPC G06N 20/20

(57) ABSTRACT

A computer-implemented method, a computer program product, and a computer system for classifying relevance of training data. A computer uses labeled data from users as training data to train a relevance classifier. A computer classifies, by the relevance classifier, the labeled data from the users into a set of groups. A computer generates, by the relevance classifier, relevant training data partitioned by the set of groups. In response to receiving a query from a user, a computer selects, from the relevant training data, relevant training samples for the user, where the relevant training samples are in one or more groups to which the user belongs. A computer selects, from relevant training samples for the user, top relevant training samples for the user. A computer uses the top relevant training samples for the user to generate a prompt of a machine learning model.

### BACKGROUND

The present invention relates generally to training of machine learning models, and more particularly to classifying the relevance of training data to a hierarchy of users.

Training of machine learning models includes training of traditional machine learning models, deep learning models, and foundation models in generative artificial intelligence. The models may be trained in different ways, for example, including trained from uninitialized weights, fine-turned on pre-trained models, an ensemble of multiple other models, and in-context few-shot prompting of pre-trained models. The training of machine learning is applied for a broad range, for example, including classification, generative models, natural language processing, and computer vision.

### SUMMARY

In one aspect, a computer-implemented method for classifying relevance of training data is provided. The computer-implemented method includes using labeled data from users as training data to train a relevance classifier. The computer-implemented method further includes classifying, by the relevance classifier, the labeled data from the users into a set of groups. The computer-implemented method further includes generating, by the relevance classifier, relevant training data partitioned by the set of groups. The computer-implemented method further includes, in response to receiving a query from a user, selecting, from the relevant training data partitioned by the set of groups, relevant training samples for the user, where the relevant training samples are in one or more groups of the set of groups, where the user belongs to the one or more groups. The computer-implemented method further includes selecting, from relevant training samples for the user, top relevant training samples for the user. The computer-implemented method further includes using the top relevant training samples for the user to generate a prompt of a machine learning model.

In another aspect, a computer program product for computer-implemented method is provided. The computer program product comprises a computer readable storage medium having program instructions embodied therewith, and the program instructions are executable by one or more processors. The program instructions are executable to: use labeled data from users as training data to train a relevance classifier; classify, by the relevance classifier, the labeled data from the users into a set of groups; generate, by the relevance classifier, relevant training data partitioned by the set of groups; in response to receiving a query from a user, select, from the relevant training data partitioned by the set of groups, relevant training samples for the user, where the relevant training samples are in one or more groups of the set of groups, where the user belongs to the one or more groups; select, from relevant training samples for the user, top relevant training samples for the user; and use the top relevant training samples for the user to generate a prompt of a machine learning model.

In yet another aspect, a computer system for computer-implemented method is provided. The computer system comprises one or more processors, one or more computer readable tangible storage devices, and program instructions stored on at least one of the one or more computer readable tangible storage devices for execution by at least one of the one or more processors. The program instructions are executable to use labeled data from users as training data to train a relevance classifier. The program instructions are further executable to classify, by the relevance classifier, the labeled data from the users into a set of groups. The program instructions are further executable to generate, by the relevance classifier, relevant training data partitioned by the set of groups. The program instructions are further executable to, in response to receiving a query from a user, select, from the relevant training data partitioned by the set of groups, relevant training samples for the user, where the relevant training samples are in one or more groups of the set of groups, where the user belongs to the one or more groups. The program instructions are further executable to select, from relevant training samples for the user, top relevant training samples for the user. The program instructions are further executable to use the top relevant training samples for the user to generate a prompt of a machine learning model.

### BRIEF DESCRIPTION OF THE SEVERAL VIEWS OF THE DRAWINGS

FIG. 1 illustrates a hierarchy of machine learning models, in accordance with one embodiment of the present invention.

FIG. 2 illustrates a naïve protocol of treating all new data as relevant globally in a hierarchy of machine learning models.

FIG. 3 illustrates a naïve protocol of treating all new data as relevant to only team models in a hierarchy of machine learning models.

FIG. 4(A) illustrates a typical architecture that uses few-shot prompting of a foundation model.

FIG. 4(B) illustrates a proposed architecture that uses few-shot prompting of a foundation model and includes provenance of training data samples and a user query, in accordance with one embodiment of the present invention.

FIG. 5 illustrates training a relevance classifier in a proposed architecture shown in FIG. 4(B), in accordance with one embodiment of the present invention.

FIG. 6 is a flowchart showing operational steps of training a relevance classifier in a proposed architecture shown in FIG. 4(B), in accordance with one embodiment of the present invention.

FIG. 7 is a flowchart showing operational steps of using relevant training data to generate a prompt of a machine learning model, in accordance with one embodiment of the present invention.

FIG. 8 is a systematic diagram illustrating an example of an environment for the execution of at least some of the computer code involved in performing for classifying relevance of training data, in accordance with one embodiment of the present invention.

### DETAILED DESCRIPTION

Because of context limits, few shot in-context samples are selected to be included in a prompt in a call to a foundation model. A common approach is to select samples similar to a test question; for example, the samples are selected based on similarity of the test question to training samples in an embedding space. In embodiments of the present invention, we consider provenance of training data and a test question; for example, we consider relationships of users who provided the training data and a test question.

Labeled training data for models is collected from users. For example, the labeled training data includes utterances for natural language intent classification (e.g., Watsonx Orchestrate). In another example, the labeled training data includes question-answer pairs for a conversational assistant (e.g., Watsonx Assistant). In yet another example, the labeled training data includes code snippets for a code generation model (e.g., Watsonx Code Assistant).

Relevance of labeled training data to users varies. The labeled training data sometimes is broadly applicable to all users, for example the labeled training data like “escalate to my manager” and “schedule a follow-up meeting”. However, the labeled training data sometimes is specific to a domain, geography, or team, for example the labeled training data like “raise this as a sev-1 issue” (which a jargon of IT operations (ITOps)) and “let's touch base soon” (which is a baseball metaphor). In a further example of the relevance of labeled training data, an HR question-answering assistant should be customized to local laws and policies. In a further example of the relevance of labeled training data, a code assistant should be customized to team coding conventions and best practices.

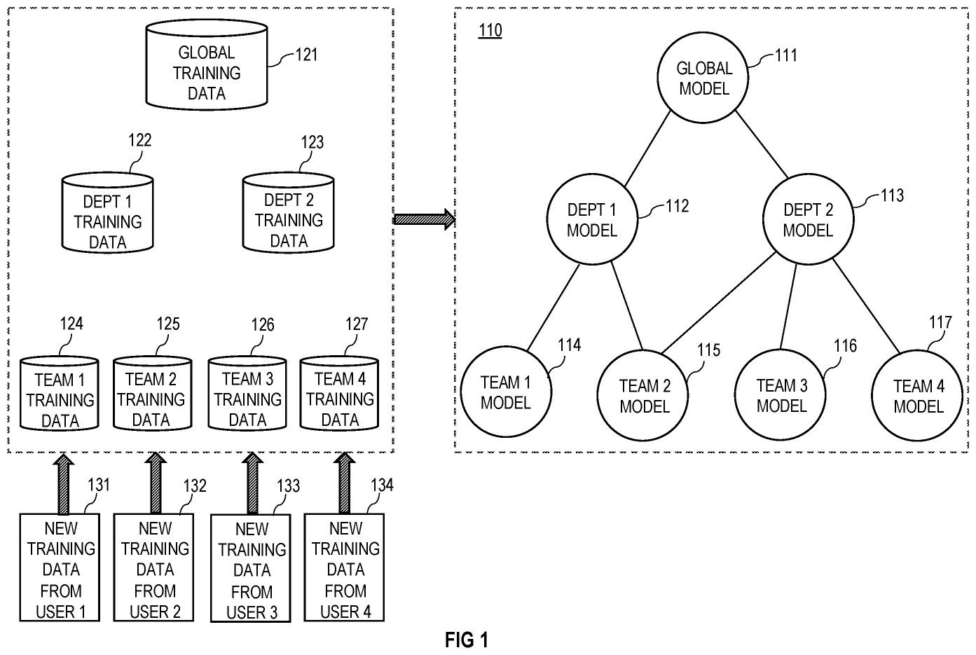

FIG. 1 illustrates a hierarchy of machine learning models, in accordance with one embodiment of the present invention. In the example shown in FIG. 1, hierarchy 110 of models includes global model 111, department level models (i.e., department 1 model 112 and department 2 model 113), and team level models (i.e., team 1 model 114, team 2 model 115, team 3 model 116, and team 4 model 117).

Global model 111 is trained on labeled training data that is broadly applicable to all users, for example global training data 121. The different department level models are fine-tuned on labeled training data relevant to different departments, respectively. For example, department 1 model 112 is fine-tuned on department 1 training data 122, and department 2 model 113 is fine-tuned on department 1 training data 123. The different team level models are further fine-tuned (or perhaps just prompted) on labeled training data relevant to different teams, respectively. For example, team 1 model 114 is further fine-tuned on team 1 training data 124, team 2 model 115 is further fine-tuned on team 2 training data 125, team 3 model 116 is further fine-tuned on team 3 training data 126, and team 4 model 117 is further fine-tuned on team 4 training data 127.

New labeled training data comes directly from users, for example, new training data 131 from user 1, new training data 132 from user 2, new training data 133 from user 3, and new training data 134 from user 4.

Embodiments of the present invention provides an approach of automatically classifying the new labeled training data according to relevance to a level of the hierarchy, thereby increasing accuracy of the models beyond what's achievable by either of the following naïve approaches.

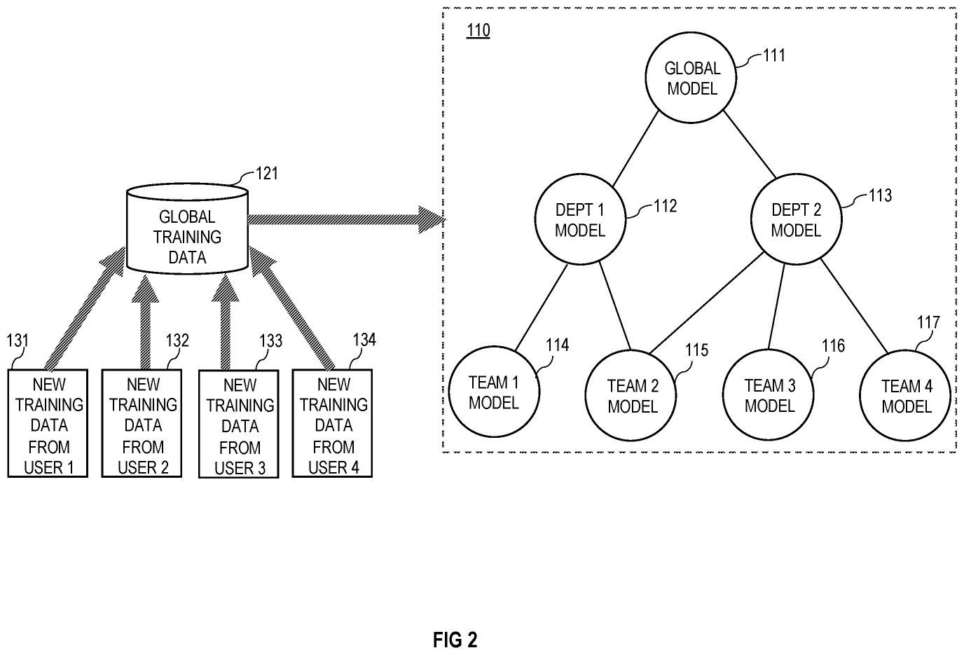

FIG. 2 illustrates a naïve approach of treating all new data as relevant globally in a hierarchy of machine learning models. In this naïve approach, new training data 131 from user 1, new training data 132 from user 2, new training data 133 from user 3, and new training data 134 from user 4 are treated as relevant globally. Global training data 121 provides a large aggregate training set from all teams (team 1, team 2, team 3, and team 4). Global training data 121 is applied to learning for team 1 model 114, team 2 model 115, team 3 model 116, and team 4 model 117. One disadvantage of the naïve approach is that global training data 121 may not be relevant to all the teams and even worse data of global training data 121 may be incorrectly labeled. Another disadvantage of the naïve approach is that treating all new data as relevant globally may not be possible due to data exposure constraints (e.g., proprietary data).

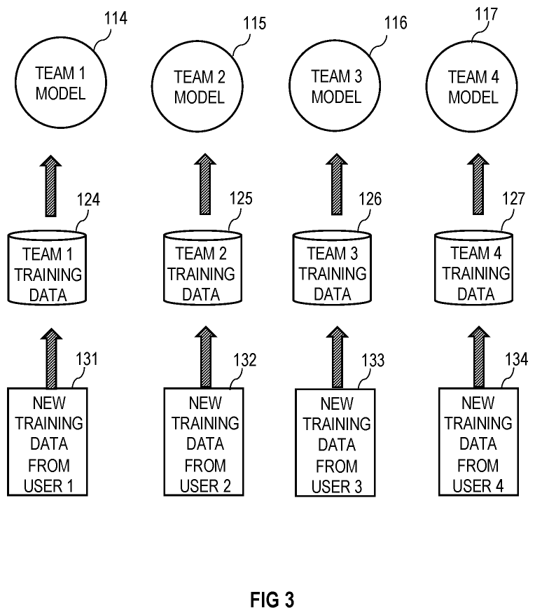

FIG. 3 illustrates a naïve protocol of treating all new data as relevant to only team models in a hierarchy of machine learning models. In this naïve approach, new training data 131 from user 1 is treated as relevant to only team 1 model 114, new training data 132 from user 2 is treated as relevant to only team 2 model 115, new training data 133 from user 3 is treated as relevant to only team 3 model 116, and new training data 134 from user 4 are treated as relevant to only team 4 model 117. This approach has a potential to increase accuracy of team-level models. With this approach, training data from one team will not pollute other team's model. However, one disadvantage of this naïve approach is that there is limited training data for different teams. Another disadvantage of this naïve approach is that there is no learning across different teams.

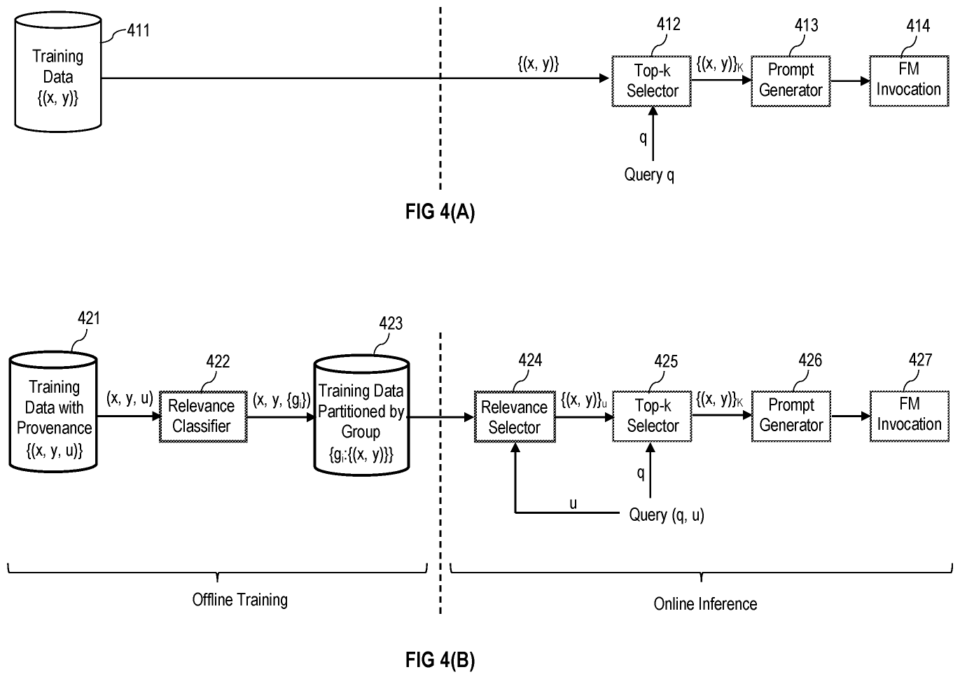

FIG. 4(A) illustrates a typical architecture that uses few-shot prompting of a foundation model (such as a GPT or generative pre-trained transform class large language model). In response to receiving a query from user, top-k selector 412 selects from training data {(x, y)} 411 k most similar samples {(x, y)}ₖ. The x is a feature vector of the training data (e.g., if the data is English sentences, then the x will be the sentence embedding for a given input sentence, where embeddings are a dense vector representation of sentences). The y is a label (e.g., if the data is English sentences for intent classification, then the y will be the intent of an input). Using the k most similar samples {(x, y)}ₖ, prompt generator 413 generates a prompt for foundation model 414.

FIG. 4(B) illustrates a proposed architecture that uses few-shot prompting of a foundation model and includes provenance of training data samples and a user query, in accordance with one embodiment of the present invention. Embodiments of the present invention extends the typical architecture (shown in FIG. 4(A)) with a goal of improving the accuracy of the foundation model. The proposed architecture includes relevance classifier 422 that determines to which groups {gi} a training sample is relevant.

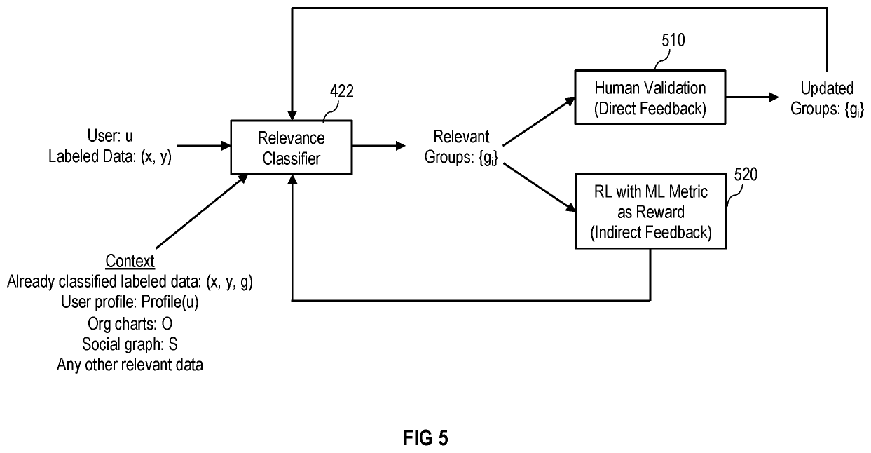

FIG. 4(B) shows an offline training stage of training relevance classifier 422. Relevance classifier 422 is trained on training data with provenance {(x, y, u)} 421, where {(x, y, u)} is training data for users. Relevance classifier 422 classifies training data {(x, y, u)} into a set of groups {gᵢ} and generates training data partitioned by group {gᵢ: {(x, y)}} 423. In the offline training stage, training relevance classifier 422 also includes direct feedback (from human labelers) and indirect feedback (with reinforcement learning or RL methods using the downstream model accuracy as a reward). Detailed discussion of the direct feedback and the indirect feedback will be given in later paragraphs with reference to FIG. 5.

The proposed architecture further includes relevance selector 424 that performs a simple lookup of training data partitioned by group {gᵢ: {(x, y)}} 423. In response to determining that user u inputs query q, relevance selector 424 selects relevant training samples {(x, y)}ᵤ from one or more of the groups that user u belongs to. Receiving query q from user u and receiving from relevance selector 424 the relevant training samples, top-k selector 425 selects from relevant training samples {(x, y)}ᵤ the k most similar samples {(x, y)}ₖ. Top-k selector 425 selects similar samples from a subset of relevant training samples {(x, y)}ᵤ rather than full corpus of training data, thereby leading to better model performance. Using the k most similar samples {(x, y)}ₖ, prompt generator 426 generates a prompt for foundation model 427.

FIG. 5 illustrates training relevance classifier 422 in a proposed architecture shown in FIG. 4(B), in accordance with one embodiment of the present invention. Relevance classifier 422 is trained to classify the relevance of labeled training data. In training relevance classifier 422, labeled training data of users {(x, y, u)} is input to train relevance classifier 422. Labeled data that has been already classified into the groups may be input to train relevance classifier 422. In addition, sources, such as profiles of users, a company organization chart or other user relationship graphs determining a group membership of the users, a social graph of the users, and all other relevant data, may be input to train relevance classifier 422. The output of training relevance classifier 422 is a set of groups {gᵢ} that users belongs to, for example the global, the departments, and the teams.

In an example of training a conversational virtual assistant capable of scheduling meetings, the proposed architecture uses features like locations and team types to train relevance classifier 422 which makes the determination of groups that users belong to. Inputs of utterances around scheduling meetings are used to improve the performance of the conversational virtual assistant. Relevance classifier 422 classifies users into right groups (e.g., global vs. geo vs. team). If input (x, y, u) is (“Let's touch base next week”, “US”, “dev”) where “dev” stands for the user development team, relevance classifier 422 determines gᵢ=geo; if input (x, y, u) is (“Please schedule a meeting next week”, “EU”, “PM”) where “PM” stands for the user product management team, relevance classifier 422 determines gᵢ=global; if input (x, y, u) is (“Block time for a debugging session”, “US”, “dev”), relevance classifier 422 determines gᵢ=team; if input (x, y, u) is (“Please schedule a meeting next week”, “India”, “dev”), relevance classifier 422 determines gᵢ=global; if input (x, y, u) is (“Let's touch base next week”, “US”, “PM”), relevance classifier 422 determines gᵢ=geo.

In training relevance classifier 422, a user similarity model is trained. The user similarity model classifies the labeled data from the users into a set of groups based on similarity between users. If a user is very similar to users in a group, then data from the user is relevant to the group. For example, if a distance between a user and users in a group is less than a predetermined number, then data from the user is relevant to the group. In training relevance classifier 422, a data similarity model is trained. The data similarity model classifies the labeled data from the users into a set of groups based on similarity of input data by the users. For example, if a distance between input from a user and inputs from users in a group is less than a predetermined number, the data from the user is relevant to the group. In training relevance classifier 422, data from a user may be manually labeled. Relevance classifier 422 is an ensemble of multi-modal similarity models (such as the above mentioned user similarity model and data similarity model). If a data point comes from a user in a group, then the data point will be included in training data for a model trained for the group because the data point from the user is relevant to all other users in the group.

Sources of data for training relevance classifier 422 include sources within the scope of the machine learning system. For example, these sources include similarity of utterances. If the machine learning system is an intent classifier, it has access to the input utterances submitted by the users of the system. Therefore, the similarity of the utterances is leveraged to classify users into groups.

Sources of data for training relevance classifier 422 further include sources that are not directly within the scope of the machine learning system. For example, these sources include distance in a social graph, similarity of user profiles, and similarity of automations that users use.

As shown in FIG. 5, to improve relevance classifier 422, the proposed architecture includes two sources of feedback on training relevance classifier 422. One source of feedback is human validation (direct feedback) 510. In the feedback, a human is involved and the human reviews the classification of the training data into the relevant groups and corrects any mistakes relevance classifier 422 may have done. Through human validation (direct feedback) 510, updated groups {gᵢ} are provided to retrain relevance classifier 422 and update models in relevance classifier 422. Therefore, relevance classifier 422 can be more accurate in future classifications of training data into a set of groups.

Another source of feedback is reinforcement learning with machine learning metric as reward (indirect feedback) 520. The proposed architecture uses reinforcement learning to learn a reward and update relevance classifier 422 based on the reward. Relevance classifier 422 is related to not only training data (such as in an active learning setup) but also feedback data which is collected by machine learning models (e.g., the global model, the department level models, and team level models shown in FIG. 1). The feedback data is received from the machine learning models and used to improve performance of relevance classifier 422. The feedback data is provided to retrain relevance classifier 422 and update models in relevance classifier 422. For example, a chatbot may allow users to provide thumbs up or thumbs down based on the chatbot's responses and the thumbs up or thumbs down are considered as the feedback to improve intent classifiers.

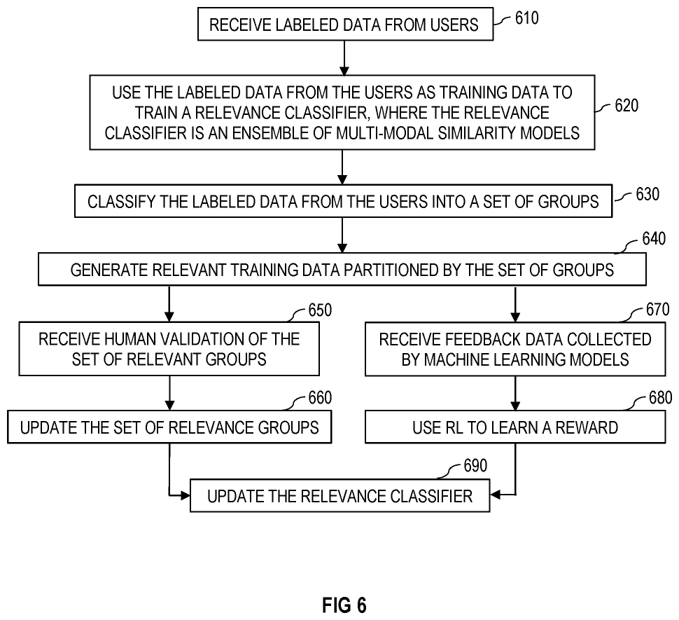

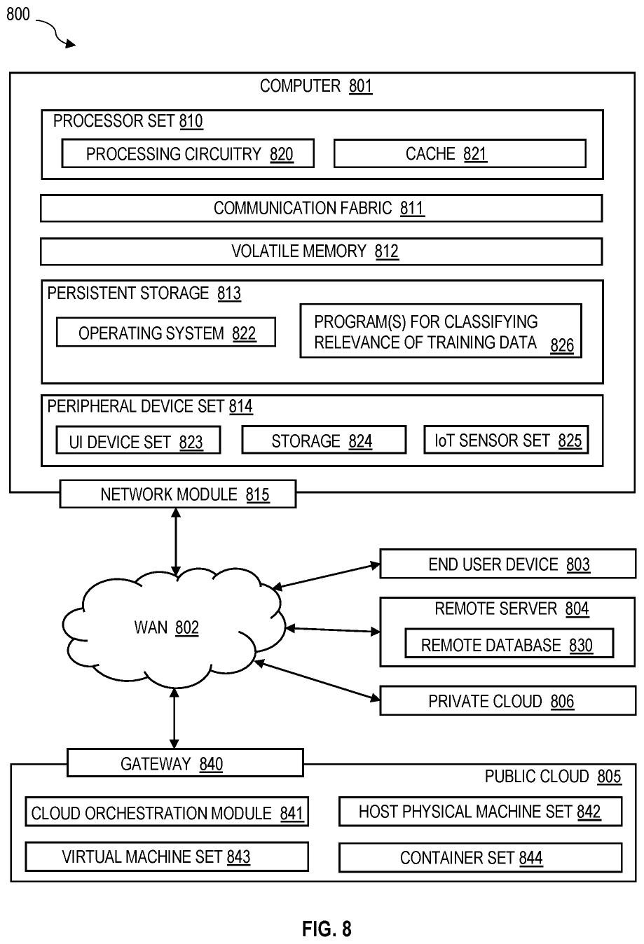

FIG. 6 is a flowchart showing operational steps of training a relevance classifier in a proposed architecture shown in FIG. 4(B), in accordance with one embodiment of the present invention. The operational steps are implemented by a computer system or server. Computer 801 shown in FIG. 8 is a typical computer system or server.

In step 610, the computer system or server receives labeled data from users. Shown in the example in FIG. 4(B), relevance classifier 422 receives {(x, y, u)} from training data with provenance {(x, y, u)} 421, where {(x, y, u)} is training data from users, where the x is a feature vector of the training data (e.g., if the data is English sentences, then x will be the sentence embedding for a given input sentence), and where the y is a label (e.g., if the data is English sentences for intent classification, then y will be the intent of an input).

In step 620, the computer system or server uses the labeled data from the users as training data to train a relevance classifier, where the relevance classifier is an ensemble of multi-modal similarity models. Shown in the example in FIG. 4(B), the labeled data {(x, y, u)} is used as training data to train relevance classifier 422.

In step 630, the computer system or server classifies the labeled data from the users into a set of relevant groups. Shown in the example in FIG. 4(B), relevance classifier 422 classifies the labeled data {(x, y, u)} into a set of relevance groups {gᵢ}.

In step 640, the computer system or server generates relevant training data partitioned by the set of relevant groups. Shown in the example in FIG. 4(B), relevance classifier 422 generates training data partitioned by group {gᵢ: {(x, y)}} 423.

In step 650, the computer system or server receives human validation of the set of relevant groups. The computer system or server receives feedback on training relevance classifier, and human validation of the set of relevant groups is one source of the feedback. Shown in the example in FIG. 5, the feedback is human validation (direct feedback) 510. In the human validation, a human reviews the classification of the training data into the set of relevant groups.

In step 660, the computer system or server updates the set of relevance groups. Upon receiving the human validation of the set of relevant groups, the computer system or server either validates the classification of the training data into the set of relevant groups or corrects any mistakes the relevance classifier may have done.

In response to the set of relevance groups being updated in step 660, the computer system or server in step 690 updates the relevance classifier. The computer system or server retrains the relevance classifier and updates models in the relevance classifier, thereby the relevance classifier can be more accurate in future classifications.

In step 670, the computer system or server receives feedback data collected by machine learning models. The feedback data is received from the machine learning models (e.g., the global model, the department level models, and team level models shown in FIG. 1) and used to improve performance of the relevance classifier.

In step 680, the computer system or server uses reinforcement learning or RL to learn a reward. With RL methods, the computer system or server uses downstream model accuracy as a reward. The computer system or server uses the reinforcement learning or RL improves performance of the relevance classifier. Based on the learned reward, the computer system or server, in step 690, updates the relevance classifier.

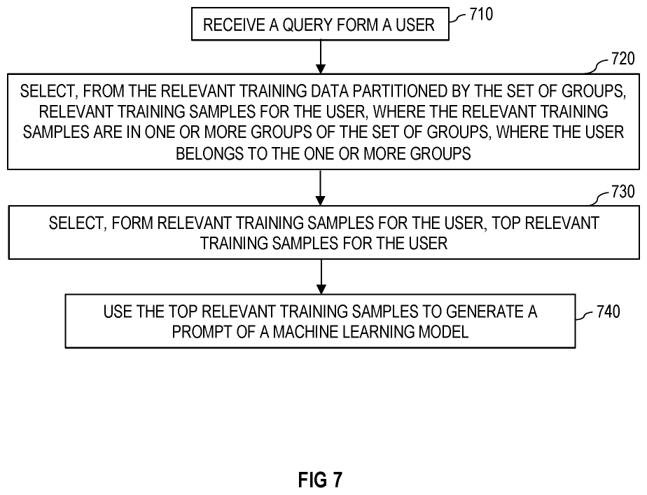

FIG. 7 is a flowchart showing operational steps of using relevant training data to generate a prompt of a machine learning model, in accordance with one embodiment of the present invention. The operational steps are implemented by a computer system or server. Computer 801 shown in FIG. 8 is a typical computer system or server

In step 710, the computer system or server receive a query from a user. In response receiving the query, in step 720, the computer or server selects, from the relevant training data partitioned by the set of groups, relevant training samples for the user, where the relevant training samples are in one or more groups of the set of groups, where the user belongs to the one or more groups. Shown in the example in FIG. 4(B), relevance selector 424 receives query q from user u. In response to receiving query q from user u, relevance selector 424 performs a lookup of training data partitioned by group {gᵢ: {(x, y)}} 423 and selects relevant training samples {(x, y)}ᵤ from training data partitioned by group {gᵢ: {(x, y)}} 423. The relevant training samples {(x, y)}ᵤ are in the one or more groups to which user u belongs.

In step 730, the computer system or server selects, from the relevant training samples for the user, top relevant training samples for the user. Shown in the example in FIG. 4(B), top-k selector 425 selects from relevant training samples {(x, y)}ᵤ the k most similar samples {(x, y)}ₖ. In step 740, the computer system or server generates a prompt of a machine learning model, using the top relevant training samples selected in step 730. Shown in the example in FIG. 4(B), prompt generator 426 generates a prompt for foundation model 427, using the k most similar samples {(x, y)}ₖ.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (CPP embodiment or CPP) is a term used in the present disclosure to describe any set of one, or more, storage media (also called mediums) collectively included in a set of one, or more, storage devices that collectively include machine readable code corresponding to instructions and/or data for performing computer operations specified in a given CPP claim. A storage device is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

In FIG. 8, computing environment 800 contains an example of an environment for the execution of at least some of the computer code involved in performing the inventive methods, such as program(s) 826 for classifying relevance of training data. In addition to block 826, computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822 and block 826, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

Computer 801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

Processor set 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located off chip. In some computing environments, processor set 810 may be designed for working with qubits and performing quantum computing.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In computing environment 800, at least some of the instructions for performing the inventive methods may be stored in block 826 in persistent storage 813.

Communication fabric 811 is the signal conduction path that allows the various components of computer 801 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 812 is any type of volatile memory now known or to be developed in the future. Examples include dynamic type random access memory (RAM) or static type RAM. Typically, the volatile memory is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

Persistent storage 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices. Operating system 822 may take several forms, such as various known proprietary operating systems or open source Portable Operating System Interface type operating systems that employ a kernel. The code included in block 826 typically includes at least some of the computer code involved in performing the inventive methods.

Peripheral device set 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In some embodiments, storage 824 may take the form of a quantum computing storage device for storing data in the form of qubits. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

Network module 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

Remote server 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

Public cloud 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as images. A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

What is claimed is:

1. A computer-implemented method for classifying relevance of training data, the computer-implemented method comprising:
using labeled data from users as training data to train a relevance classifier;
classifying, by the relevance classifier, the labeled data from the users into a set of groups;
generating, by the relevance classifier, relevant training data partitioned by the set of groups;
in response to receiving a query from a user, selecting, from the relevant training data partitioned by the set of groups, relevant training samples for the user, the relevant training samples being in one or more groups of the set of groups, the user belonging to the one or more groups;
selecting, from relevant training samples for the user, top relevant training samples for the user; and
using the top relevant training samples for the user to generate a prompt of a machine learning model.

2. The computer-implemented method of claim 1, further comprising:
receiving human validation of the set of relevant groups;
updating the set of relevance groups, based on the human validation; and
updating the relevance classifier based on updated set of relevance groups.

3. The computer-implemented method of claim 1, further comprising:
receiving feedback from the machine learning model;
using reinforcement learning to learn a reward;
updating the relevance classifier based on the reward.

4. The computer-implemented method of claim 1, wherein the relevance classifier is an ensemble of multi-modal similarity models.

5. The computer-implemented method of claim 1, further comprising:
training a user similarity model, wherein the user similarity model classifies the labeled data from the users into the set of groups based on similarity between users; and
wherein the relevance classifier includes the user similarity model.

6. The computer-implemented method of claim 1, further comprising:
training a data similarity model, wherein the data similarity model classifies the labeled data from the users into the set of groups based on similarity of input data by the users; and
wherein the relevance classifier includes the data similarity model.

7. The computer-implemented method of claim 1, wherein the training data further includes labeled data that has been classified into the set of groups, profiles of the users, an organization chart, a social graph of the users.

8. A computer program product for classifying relevance of training data, the computer program product comprising a computer readable storage medium having program instructions stored therewith, the program instructions executable by one or more processors, the program instructions executable to:
use labeled data from users as training data to train a relevance classifier;
classify, by the relevance classifier, the labeled data from the users into a set of groups;
generate, by the relevance classifier, relevant training data partitioned by the set of groups;
in response to receiving a query from a user, select, from the relevant training data partitioned by the set of groups, relevant training samples for the user, the relevant training samples being in one or more groups of the set of groups, the user belonging to the one or more groups;
select, from relevant training samples for the user, top relevant training samples for the user; and
use the top relevant training samples for the user to generate a prompt of a machine learning model.

9. The computer program product of claim 8, further comprising the program instructions executable to:
receive human validation of the set of relevant groups;
update the set of relevance groups, based on the human validation; and
update the relevance classifier based on updated set of relevance groups.

10. The computer program product of claim 8, further comprising the program instructions executable to:
receive feedback from the machine learning model;
use reinforcement learning to learn a reward;
update the relevance classifier based on the reward.

11. The computer program product of claim 8, wherein the relevance classifier is an ensemble of multi-modal similarity models.

12. The computer program product of claim 8, further comprising the program instructions executable to:
train a user similarity model, wherein the user similarity model classifies the labeled data from the users into the set of groups based on similarity between users; and
wherein the relevance classifier includes the user similarity model.

13. The computer program product of claim 8, further comprising the program instructions executable to:
train a data similarity model, wherein the data similarity model classifies the labeled data from the users into the set of groups based on similarity of input data by the users; and
wherein the relevance classifier includes the data similarity model.

14. The computer program product of claim 8, wherein the training data further includes labeled data that has been classified into the set of groups, profiles of the users, an organization chart, a social graph of the users.

15. A computer system for classifying relevance of training data, the computer system comprising one or more processors, one or more computer readable tangible storage devices, and program instructions stored on at least one of the one or more computer readable tangible storage devices for execution by at least one of the one or more processors, the program instructions executable to:
use labeled data from users as training data to train a relevance classifier;
classify, by the relevance classifier, the labeled data from the users into a set of groups;
generate, by the relevance classifier, relevant training data partitioned by the set of groups;
in response to receiving a query from a user, select, from the relevant training data partitioned by the set of groups, relevant training samples for the user, the relevant training samples being in one or more groups of the set of groups, the user belonging to the one or more groups;
select, from relevant training samples for the user, top relevant training samples for the user; and
use the top relevant training samples for the user to generate a prompt of a machine learning model.

16. The computer system of claim 15, further comprising the program instruction executable to:
receive human validation of the set of relevant groups;
update the set of relevance groups, based on the human validation; and
update the relevance classifier based on updated set of relevance groups.

17. The computer system of claim 15, further comprising the program instructions executable to:
receive feedback from the machine learning model;
use reinforcement learning to learn a reward;
update the relevance classifier based on the reward.

18. The computer system of claim 15, wherein the relevance classifier is an ensemble of multi-modal similarity models.

19. The computer system of claim 15, further comprising program instructions executable to:
train a user similarity model, wherein the user similarity model classifies the labeled data from the users into the set of groups based on similarity between users; and
wherein the relevance classifier includes the user similarity model.

20. The computer system of claim 15, further comprising program instructions executable to:
train a data similarity model, wherein the data similarity model classifies the labeled data from the users into the set of groups based on similarity of input data by the users; and
wherein the relevance classifier includes the data similarity model.
